(19) United States
(12) Patent Application Publication
(10) Pub. No.: US 2024/0413923 A1
(43) Pub. Date: Dec. 12, 2024

(54) METHOD FOR PROCESSING A GNSS SIGNAL WITH A VIEW TO ATTENUATING AT LEAST ONE JAMMING SIGNAL

(71) Applicant: Safran Electronics & Defense, PARIS (FR)

(72) Inventors: Alain Michel CHIODINI, MOISSY-CRAMAYEL (FR); Arnaud LILBERT, MOISSY-CRAMAYEL (FR)

(73) Assignee: Safran Electronics & Defense, PARIS (FR)

(21) Appl. No.: 18/698,143

(22) PCT Filed: Oct. 4, 2022
(86) PCT No.: PCT/FR2022/051874

§ 371 Date: Apr. 3, 2024

(30) Foreign Application Priority Data
Oct. 4, 2021 (FR) 2110456

(51) Int. Cl. H04K 3/00

(52) U.S. Cl. CPC H04K 3/22; H04K 3/25

(57) ABSTRACT

The invention relates to a method for processing a radio navigation signal originating from a satellite (SAT) and received by a radio navigation receiver comprising a plurality of receive antennas, each antenna being configured to receive signals originating from a satellite of interest (SAT), from at least one jammer and possibly from at least one other satellite (SAT′) in given directions, the method comprising the following steps: detecting (E1), on the basis of the signal received by each antenna, at least one direction of a jamming signal; attenuating (E2, E2′) the detected jamming signal in the detected direction; in which method detecting (E1) the direction of a jamming signal is based on determining a covariance matrix dependent on the signals received by each antenna given by (i), where Z is a matrix of size N×M in which each column corresponds to the signal received by each antenna, N denoting the number of samples acquired during a fixed period ΔT and M being the number of antennas.

### TECHNICAL FIELD

The invention relates to a method and a device for processing and eliminating interference in signals received by an array of several antennas of a satellite positioning receiver or GNSS (Global Navigation Satellite Systems) receiver. And the invention applies in particular to the elimination of interference in a satellite signal received by such a receiver.

### STATE OF THE ART

Satellite positioning systems, or GNSS (GPS, GALILEO, GLONASS) systems operate in the radio bands dedicated to this use and located in L-band (i.e. between 1 and 2 GHZ). Like any radio receiver, they are likely to be accidentally or intentionally jammed. Used in particular to facilitate transport (sea, river, land and air transport) and to enable the smooth running of industrial, scientific and military applications, their jamming can endanger civilians, industrial processes and military men in operation. It is therefore appropriate to deploy appropriate anti-jamming solutions wherever necessary.

Such anti-jamming solutions are based on a spatial processing device comprising a Controlled Radiation Pattern Antenna (CRPA) located upstream of the GNSS receiver and aimed at mitigating the negative impact of the jammers on the performance of the receiver.

Such processing operations consist of forming an apparent antenna by weighting in amplitude and phase the signals coming from elementary sensors before summing them so as to form a single signal. In fact, it involves using a receiver of spatially separated antennas and, through an adequate combination of the signals received by each antenna, attenuating the unwanted signals in all directions they come from.

### DISCLOSURE OF THE INVENTION

The object of the invention relates to a signal processing method making it possible to eliminate interference affecting a signal received by an array of antennas, for example a satellite signal received by a GNSS receiver.

To this end, the invention proposes a method for processing a radio navigation signal coming from a satellite received by a radio navigation receiver comprising several receiving antennas, each antenna being configured to receive signals coming from a satellite of interest, at least one jammer and possibly at least another satellite in given directions, the method comprising the following steps:
detecting, from the signal received by each antenna, at least one direction of a jamming signal;
attenuating the detected jamming signal in the detected direction;
method in which the detection of the direction of a jamming signal comprises the steps of:
determining a covariance matrix function of the signals received by each antenna given by R_{ZZ}=1/NZ^{H}Z with Z a matrix of size N×M where each column corresponds to the signal received by each antenna, N denoting the number of samples acquired during a set period ΔT and M being the number of antennas;
carrying out a singular value decomposition of the covariance matrix:

$${R}_{zz} = {\sum }_{m = 1}^{M} {λ}_{m} {U}_{m} {U}_{m}^{H}$$

where λₘ are the eigenvalues, components being characteristic of the useful and jamming signals and other noise characteristics;
comparing the eigenvalues together so as to detect the presence of at least one jammer;
determining an indicator function of a direction of arrival θ comprised between [0; 2π[, the indicator being a function of a scalar between a spatial signature model of a jammer S(θ) and U_{M}^{H} which corresponds to the noise subspace of the noise space resulting from the decomposition, U_{M}^{H} and S(θ) being orthogonal for a jammer in the direction θ;
a jammer being present in the direction θ for which the indicator is lower than a given threshold.

The invention is advantageously supplemented by the following characteristics, taken alone or in any of their technically possible combinations:
the comparison comprises a determination of a number of jammers by comparison in pairs of the eigenvalues by successively calculating a coefficient

$${ρ}_{i , M} = \frac{{λ}_{i}}{{λ}_{M}} ,$$

i varying from M−1 to 1, the number of jammers being equal to i for ρ_{i,M} greater than a determined threshold, preferably equal to 8(ρ_{i,M})ₙₒᵢₛₑ;
the indicator is given by [symbol] (θ)=log₂|U_{M}^{H}S(θ)|, a jammer being present in the direction θ for which the indicator is lower than a given threshold;
a detected number B of jammers is known, a jammer being present in the B directions θ for which the corresponding indicator is lower than the threshold;
the detected number of jammers is less than or equal to M−2, the indicator being given by [symbol] (θ)=Σ_{M=B+1}^{M} log₂|Uₘ^{H}S(θ)|, where B is the number of jammers, a jammer being present in the M−2 directions θ lower than the threshold;
several directions are obtained over time for each detected jammer, the method comprising a time filter of the directions obtained for each jammer;
the attenuation comprises the determination of a set of weighting coefficients w_{CRPA} or w_{CRPA}^{(s)} associated with a satellite of interest making it possible to attenuate the jamming signal received in the thus detected directions and making it possible to attenuate, where appropriate, the signals coming from other satellites so as to optimize the signal coming from the satellite of interest;
the receiver receiving signals coming from a single satellite, the determination of the coefficient w_{CRPA} making it possible to attenuate the jamming signal received in the determined directions comprises the steps of:
determining a reference vector

$${w}^{( 0 )} = ( \begin{matrix}1 \\ i \\ - 1 \\ - i\end{matrix} ) ;$$

determining a weighting coefficient associated with each jammer or jamming direction

$${w}_{jammer}^{( p )} ( {\hat{ϕ}}_{p} ) = ( \begin{matrix}{e}^{{ihd}_{1} ( {\hat{ϕ}}_{p} )} \\ {e}^{{ihd}_{2} ( {\hat{ϕ}}_{p} )} \\ {e}^{{ihd}_{3} ( {\hat{ϕ}}_{p} )} \\ {e}^{{ihd}_{4} ( {\hat{ϕ}}_{p} )}\end{matrix} ) , 1 \leq p \leq B$$

where d₁(\hat{φ}p)=0, d₂(\hat{ϕ}ₚ)=d cos(\hat{ϕ}ₚ), d₃(\hat{ϕ}ₚ)=d cos(\hat{ϕ}ₚ)+d sin(\hat{ϕ}ₚ), d₄(\hat{ϕ}ₚ)=d sin (\hat{ϕ}ₚ)
determining a rectangular or square matrix of size 4×(B+1);

$$ℳ = ( {w}^{( 0 )} {\underbrace{{w}_{\hat{ϕ}}^{( 1 )} … {w}_{\hat{ϕ}}^{( B )}}}_{B columns} )$$

determining the set of weighting coefficients

w_{CRPA}= [symbol] ₁

with [symbol] ₁ the first component of the vector [symbol] =( [symbol] )^{H}=( [symbol] ₁ . . . [symbol] _{B-1} [symbol] _{B}) with

[symbol]

= [symbol] ^{†}+=( [symbol] ^{H} [symbol] )⁻¹ [symbol] ^{H}

if B<3 or [symbol] = [symbol] ⁻¹ if B=3.
the receiver receives signals from S>1 satellites, the determination of the coefficient making it possible to optimize the received signal associated with a satellite of interest and making it possible to attenuate the jamming signal in the determined directions and that of the other satellites, comprises the steps of:
determining a weighting coefficient w_{\hat{ξ}}^{(s)} associated with each satellite s:

$${w}_{\hat{ξ}}^{( s )} = ( \begin{matrix}{1}_{} ( {\hat{ξ}}^{( s )} ) \\ {2}_{} ( {\hat{ξ}}^{( s )} ) \\ {3}_{} ( {\hat{ξ}}^{( s )} ) \\ ⋮ \\ {M - 1}_{} ( {\hat{ξ}}^{( s )} ) \\ {M}_{} ( {\hat{ξ}}^{( s )} )\end{matrix} ) = ( \begin{matrix}1 \\ {2}_{} ( {\hat{ξ}}_{AZIM}^{( s )} , {\hat{ξ}}_{ELEV}^{( s )} ) \\ {3}_{} ( {\hat{ξ}}_{AZIM}^{( s )} , {\hat{ξ}}_{ELEV}^{( s )} ) \\ ⋮ \\ {M - 1}_{} ( {\hat{ξ}}_{AZIM}^{( s )} , {\hat{ξ}}_{ELEV}^{( s )} ) \\ {M}_{} ( {\hat{ξ}}_{AZIM}^{( s )} , {\hat{ξ}}_{ELEV}^{( s )} )\end{matrix} ) for \leq s \leq S$$

where [symbol] : denotes the wave number, dₘ denotes the path difference relative to the reference antenna, \hat{ξ}^{(s)}=(\hat{ξ}_{AZIM}^{(s)}, \hat{ξ}_{ELEV}^{(s)}) is the direction of arrival of the received signal coming from the satellite of index s, \hat{ξ}_{AZIM}^{(s)} being the azimuthal component and \hat{ξ}_{ELEV}^{(s)} being the elevation component;
determining a weighting coefficient w_{\hat{ϕ}}^{(b)} associated with each jammer in each determined direction:

$${w}_{\hat{ϕ}}^{( b )} = ( \begin{matrix}{1}_{} ( {\hat{ϕ}}^{( b )} ) \\ {2}_{} ( {\hat{ϕ}}^{( b )} ) \\ {3}_{} ( {\hat{ϕ}}^{( b )} ) \\ ⋮ \\ {M - 1}_{} ( {\hat{ϕ}}^{( b )} ) \\ {M}_{} ( {\hat{ϕ}}^{( b )} )\end{matrix} ) = ( \begin{matrix}1 \\ {2}_{} ( {\hat{ϕ}}_{AZIM}^{( b )} ) \\ {3}_{} ( {\hat{ϕ}}_{AZIM}^{( b )} ) \\ ⋮ \\ {M - 1}_{} ( {\hat{ϕ}}_{AZIM}^{( b )} ) \\ {M}_{} ( {\hat{ϕ}}_{AZIM}^{( b )} )\end{matrix} ) for 1 \leq b \leq B$$

determining a matrix [symbol] of size M×(S+B) where S is the number of satellites, B is the number of jammers or jamming directions and M is the number of antennas:

$$ℳ = ( {w}_{\hat{ξ}}^{( z )} {\underbrace{… {w}_{\hat{ξ}}^{( s )} …}}_{{S - 1 columns}_{s = s}} {\underbrace{\begin{matrix}{w}_{\hat{ϕ}}^{( 1 )} & {w}_{\hat{ϕ}}^{( 2 )} & … & {w}_{\hat{ϕ}}^{( B - 1 )} & {w}_{\hat{ϕ}}^{( B )}\end{matrix}}}_{B columns} )$$

determining the set of weighting coefficients associated with a satellite [symbol] of interest

w_{CRPA}⁽ [symbol] ⁾= [symbol] ₁

with [symbol] ₁ the first component of the vector [symbol] = [symbol] ^{H}=( [symbol] ₁ [symbol] ₂ . . . [symbol] _{S+B-1} [symbol] _{S+B}) with [symbol] = [symbol] ^{†}=( [symbol] ^{H} [symbol] )⁻¹ [symbol] ^{H} if S+B<M or [symbol] = [symbol] ⁻¹ if S+B=M
(⋅) H: denoting the operation “transposition (noted (⋅)^{T})+complex conjugation (noted (⋅)*”.

The invention also proposes a computer program product comprising code instructions for implementing a method according to the invention, when the latter is executed by a computer.

The invention is based on the fact that the power of the useful signals (GNSS signals emitted by the satellites) is always much lower than the noise of the receiver. The eigenvalues of the signal space therefore mainly reflect the power of the received jamming signals. In other words, λₘ are the eigenvalues of the components being essentially characteristic of the jamming signals and other noise characteristics.

The invention consists of exploiting the noise subspace obtained from the covariance matrix of the multi-channel signal provided by the array of antennas. A metric is constructed for an angular domain scanned by performing the scalar product between the eigenvector associated with the noise subspace and the spatial signature function of the direction of arrival of the source to be detected. The thus constituted metric reveals as many notches as there are sources present in the radio environment captured by the array of antennas.

### PRESENTATION OF THE FIGURES

Other characteristics, aims and advantages of the invention will emerge from the following description, which is purely illustrative and not limiting, and which should be read in relation to the appended drawings in which:

FIG. 1 illustrates a receiver according to the invention;

FIG. 2 illustrates a possible configuration of an antenna plate according to the invention;

FIG. 3 illustrates steps of a method according to the invention;

FIG. 4 illustrates a distribution of the eigenvalues of a covariance matrix obtained from a matrix segment consisting of four Gaussian random signals of 1,024 samples resulting from four reduced centered Gaussian random variables;

FIG. 5 illustrates a metric obtained according to the method of the invention to detect one or more jammer(s) in a direction of arrival.

In all the figures, similar elements bear identical references.

### DETAILED DESCRIPTION

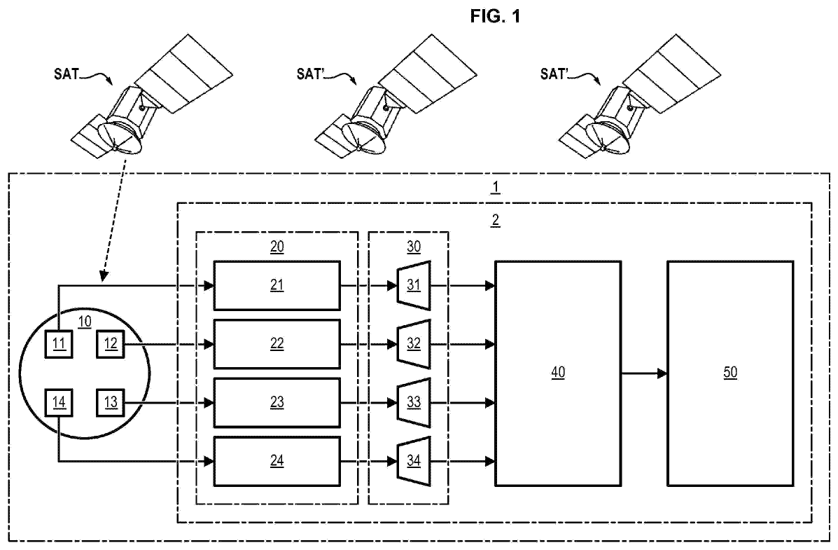

FIG. 1 illustrates a GNSS receiver 1 comprising an array of antennas, for example of the patch type, disposed on an antenna plate 10. The GNSS signals received by each antenna 11, 12, 13, 14 are transmitted to a processing unit 2 comprising several successive stages. A processing unit is for example a processor configured to implement different processing operations on the signals as will be seen later.

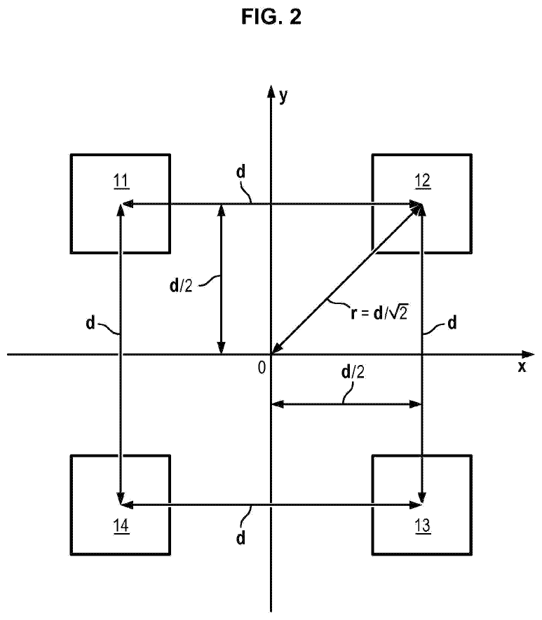

Preferably, the plate includes four antennas 11, 12, 13, 14. The following description is placed in the case of four antennas, but the invention also applies to a different number of antennas (noted M in the following). A configuration of an antenna plate is illustrated in FIG. 2.

Furthermore, it is considered that the gain and phase calibration of the antennas has been previously carried out with appropriate hardware and software (algorithmic) means. Such an operation is indeed carried out before the acquisition.

In known manner, the calibration operation makes it possible to measure (in order to subsequently cancel them) the dispersive gains and phase shifts introduced by the receive chains associated with the antennas.

An incident signal s_{ϕ} (where ϕ denotes the angle of incidence of the interfering signal) is received by each antenna connected to a stage 20 comprising radio units 21, 22, 23, 24 per antenna of known type allowing filtering of the signals, amplification and transposition into an intermediate frequency lower than the carrier frequency of the received signal. The signals are then digitized by an analog/digital conversion unit 30 comprising an analog/digital converter 31, 32, 33, 34 per signal received on each antenna.

Each converter provides digital samples that contain navigation information (useful data), jamming components and noise inherent in any radio transmission.

These digital samples are provided to a module 40 that operates on the principle of the CRPA algorithm which makes it possible to attenuate signals due to jammers. It is considered here that a jammer is the emission in one direction of jamming or interfering signals on the receiver 1.

Indeed, the received samples coming from each antenna are weighted by weighting coefficients that make it possible to attenuate or eliminate the components due to the jammers. Particularly, these weighting coefficients make it possible to attenuate interfering signals in given directions, which amounts to creating a kind of notches in the radiation pattern of the array of antennas since some directions are not taken into account in this case.

Returning to FIG. 1, the output signal of the module 40 is therefore a linear combination of the weighted digital signals, namely for an output sample n:

$$\hat{s} = {\sum }_{m = 1}^{M} {w}_{CRPA} ( m ) {z}_{m}$$

or in vector notation ŝ=Zw_{CRPA} where ŝ is a signal whose interference due to jammers is attenuated, and where zₙ is the signal coming from each antenna after analog-to-digital conversion and w_{CRPA} is the vector containing the weightings to be applied to each channel, M being the number of antennas.

Indeed, the set of coefficients w_{CRPA} makes it possible to attenuate the signals received in some directions, the signal s being a linear combination of the signals received by each antenna weighted by weighting coefficients attenuating the signal in directions in which a jamming signal is received. The set of coefficients w_{CRPA} is a vector whose components are complex scalars.

Then, this signal s is provided to a unit 50 which makes it possible to calculate the navigation data (not described here because well known to those skilled in the art).

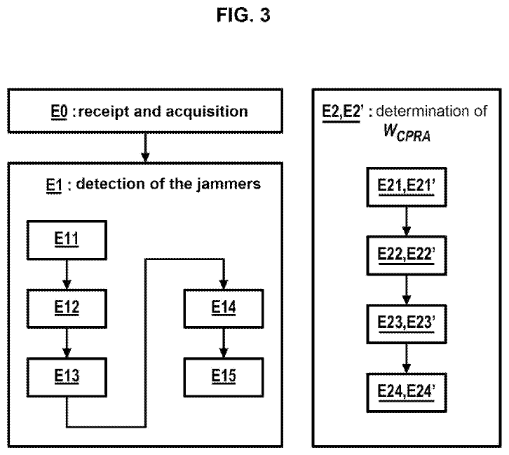

Returning to the module 40, the latter implements steps of a method for processing the signals received in order to weight these signals to attenuate the jammers described below and in relation to FIG. 3.

To do so, the unit 40 detects from the signal received and acquired (step E0) by each antenna, at least one direction of a jamming signal (step E1) then determines (step E2) for each direction of weighting coefficients to be applied to the signals received by each antenna, these coefficients making it possible to attenuate the signal received in the direction of the jamming signal.

Acquisition (step E0)

An incident signal is acquired (step E0) and formed of several series of N samples (1 series per antenna). The incident signal can be written in matrix form. Particularly, the incident signal s_{ϕ} at the output of the unit 30 (in vector notation) is given by:

Z(k)=[s_{N}⁽¹⁾(k)s_{N}⁽²⁾(k)s_{N}⁽³⁾(k)s_{N}⁽⁴⁾(k)]

where Z is a matrix of dimension N×4 where N represents the number of samples acquired during the period ΔT=NT_{S}, T_{S} being the sampling period of the digitized signals coming from the unit 30 and the number 4 corresponding to the number of antennas.

The signals s_{N}^{(m)}(k)(1≤m≤4), correspond to column vectors of dimensions N×1:

$${s}_{N}^{m} ( k ) = ( \begin{matrix}{s}^{( m )} ( k Δ T ) \\ {s}^{( m )} ( k Δ T + {T}_{s} ) \\ ⋮ \\ {s}^{( m )} ( k Δ T + ( N - 2 ) {T}_{s} ) \\ {s}^{( m )} ( k Δ T + ( N - 1 ) {T}_{s} )\end{matrix} )$$

It is assumed that the jammers are located in the azimuthal plane (terrestrial jammers).

The matrix Z has as dimensions: N×M, M being the number of antennas. The integer k indicates that the (k+1)^{th} time slot (the first slot being arbitrarily indexed by 0) is considered. In summary, the analog-to-digital converters provide a continuous “signal trace” segmented into contiguous portions of duration ΔT. Each of these portions is indexed by k.

### Detection of the Jammers (Step E1)

In a step E11, the covariance matrix of the received multi-channel signal coming from the antennas is obtained. Particularly, the multichannel signal divided into contiguous time sections Z(k) of N×M samples is considered, where M denotes the number of antenna elements of the array of antennas and N the number of time samples to calculate the matrix of covariance R_{ZZ} as follows:

R_{ZZ}==1/NZ^{H}Z

This matrix R_{ZZ} can be written as follows by singular value decomposition (SVD) (step E12)

$${R}_{Z Z} = {\sum }_{m = 1}^{M} {λ}_{m} {U}_{m} {U}_{m}^{H}$$

where λₘ denotes the eigenvalue associated with the eigenvector Uₘ

This decomposition can be interpreted in different ways. There are M+1 possibilities:
1^{st} possibility (no jamming signal): the signal subspace corresponds to the empty set {∅} and the noise subspace corresponds to {U₁, . . . , U_{M}}
2^{nd} possibility (1 jamming signal): the signal subspace corresponds to {U₁} and the noise subspace corresponds to {U₂, . . . , U_{M}}
3^{rd} possibility (2 jamming signals): the signal subspace corresponds to {U₁, U₂} and the noise subspace corresponds to {U₃, . . . , U_{M}}
. . .
m^{th} possibility (m−1 jamming signals): the signal subspace corresponds to {U₁, . . . , Uₘ₋₁} and the noise subspace corresponds to {Uₘ, . . . , U_{M}}
. . .
M^{th} possibility (M−1 jamming signals): the signal subspace corresponds to {U₁, . . . , U_{M-1}} and the noise subspace corresponds to {U_{M}}
(M+1)^{th} possibility (M jamming signals): the signal subspace corresponds to {U₁, . . . , U_{M}} and the noise subspace corresponds to {∅}

The invention consists in exploiting the noise subspace obtained from the covariance matrix of the multi-channel signal provided by the array of antennas. In what follows, the singular value decomposition of the covariance matrix will be noted as follows: R_{ZZ}= [symbol] Λ [symbol] ^{H} with [symbol] =( [symbol] ₁ [symbol] ₂ . . . . [symbol] _{M-1} [symbol] _{M}) where { [symbol] ₘ}_{1≤m≤M} denotes the set of eigenvectors and Λ=diag (λ₁, λ₂, . . . , λ_{M-1}, λ_{M}) denotes the set of eigenvalues which are respectively associated with them with λ₁≥λ₂≥ . . . ≥λ_{M-1}≥λ_{M}≥0.

Thus, any jammers possibly present in the radio environment are detected (step E13).

Such detection consists in comparing the eigenvalues of the covariance matrix with a threshold.

Indeed, the singular value decomposition of this matrix makes it possible to carry out a statistical interpretation of the acquired signals. The signal subspace, represented by the column vectors [symbol] ₁, [symbol] ₂ and [symbol] ₃ of the matrix [symbol] , is an ellipsoid whose semi-axes correspond to these column vectors. Weighted respectively by the eigenvalues λ₁, λ₂ and λ₃, they indicate the directions of greatest variation of the set of signals constituting the matrix segment. As for the noise subspace, it is represented at a minimum by the column vector [symbol] ₄ when the number of sources present in the radio environment is less than or equal to 3. The following table characterizes the signal and noise subspaces as a function of the number of sources B present in the radio environment:

| | Signal subspace | | Noise subspace | |
|---|---|---|---|---|
| B | Dimension | Generated by | Dimension | Generated by |
| 0 | 0 | — | 4 | Υ₄, Υ₃, Υ₂, Υ₁ |
| 1 | 1 | Υ₁ | 3 | Υ₄, Υ₃, Υ₂ |
| 2 | 2 | Υ₁, Υ₂ | 2 | Υ₄, Υ₃ |
| 3 | 3 | Υ₁, Υ₂, Υ₃ | 1 | Υ₄ |
| ≥4 | 4 | Υ₁, Υ₂, Υ₃, Υ₄ | 0 | — |

In what follows, it is assumed that the jammers are independent in pairs and that the power of the noise (AWGN) of the receiver is zero.

Let B be the number of jammers.

In the case where B=1, the spatial signature of the source (b₁) corresponds to a simple weighting and conjugation of the column vector [symbol] 1:

[symbol]

₁=a₁ [symbol] ₁*

where a₁∈ [symbol] .

In the case where B=2, the spatial signature of the sources (b₁ and b₂) corresponds to a linear combination of the conjugated column vectors [symbol] ₁ and [symbol] ₂:

[symbol]

₁=a₁ [symbol] ₁*+b₁ [symbol] ₂*

[symbol]

₂=a₂ [symbol] ₁*+b₂ [symbol] ₂*

where a₁, b₁, b₂, b₂ ∈ [symbol] .

In the case where B=3, the spatial signature of the sources (b₁, b₂ and b₃) corresponds to a linear combination of the conjugated column vectors [symbol] ₁, [symbol] ₂ and [symbol] ₃:

[symbol]

₁=a₁ [symbol] ₁*+b₁ [symbol] ₂*+c₁ [symbol] ₃*

[symbol]

₂=a₂ [symbol] ₁*+b₂ [symbol] ₂*+c₂ [symbol] ₃*

[symbol]

₃=a₃ [symbol] ₁*+a₃ [symbol] ₂*+c₃ [symbol] ₃*

where a₁, b₁, c₁, a₂, b₂, c₂, a₃, b₃, c₃ ∈ [symbol] .

If B≤3, it is observed that the product [symbol] ₘ^{T} [symbol] ₄=0 for m∈{1,2,3} since the matrix [symbol] is unitary. Thus, if at most three jammers are to be cancelled, the set of weights to use is ideally:

w= [symbol] ₄

If B≥4, the spatial signature of the jammers bₘ for m∈{1, 2, . . . , B} corresponds to a linear combination of the column vectors [symbol] ₁, [symbol] ₂, [symbol] ₃ and [symbol] ₄ after conjugation:

[symbol]

₁=a₁ [symbol] ₁*+b₁ [symbol] ₂*+c₁ [symbol] ₃*+d₁ [symbol] ₄*

[symbol]

₂=a₂ [symbol] ₁*+b₂ [symbol] ₂*+c₂ [symbol] ₃*+d₂ [symbol] ₄*

[symbol]

_{B}=a_{B} [symbol] ₁*+b_{B} [symbol] ₂*+c_{B} [symbol] ₃*+d_{B} [symbol] ₄*

where a₁, b₁, c₁, d₁, a₂, b₂, c₂, d₂, . . . , a_{B}, b_{B}, c_{B}, d_{B} ∈ [symbol] .

Unlike the previous case, a vector [symbol] ₅ such as [symbol] ₘ^{T} [symbol] ₅=0 Λm∈{1, 2, . . . , B} cannot be proposed or constructed. Indeed, if such a vector exists, it necessarily decomposes into the orthonormal basis [symbol] B=( [symbol] ₁, [symbol] ₂, [symbol] ₃, [symbol] ₄) as follows:

[symbol]

₅=a₀ [symbol] ₁+b₀ [symbol] ₂+c₀ [symbol] 3+d₀ [symbol] ₄

where a₀, b₀, c₀, d₀, ∈ [symbol] .

or,

[symbol]

ₘ^{T} [symbol] ₅=0 Λm∈{1, 2, . . . , B}

⇒aₘa₀+bₘb₀+cₘc₀+dₘd₀=0 ∀m∈{1, 2, . . . , B}

⇒a₀=b₀=c₀=d₀=0− [symbol] ₅=\vec{0}

These considerations explain why more than three jammers when an antenna plate comprising four antenna elements is used cannot be canceled.

The generalization of this property to an arbitrary number of antenna elements is immediate. It is noted that more than M−1 jammers when an antenna plate comprising M antenna elements is used cannot be canceled.

It is now assumed that there is a noise of power σ² per receive channel (in the absence of sources, the singular value decomposition of the covariance matrix Cₜ⁽⁰⁾ reveals the following eigenvalues: (λ₁=σ₁²)>(λ₂=σ₂²)>(λ₃=σ₃²)>(λ₄=σ₄²); the conditioning λ₁/λ₄ of the matrix Λ is then close to 2). The method used to detect and identify the present sources is based on the comparison of the eigenvalues of the matrix Λ:

$$Λ = ( \begin{matrix}{λ}_{1} & 0 & 0 & 0 \\ 0 & {λ}_{2} & 0 & 0 \\ 0 & 0 & {λ}_{3} & 0 \\ 0 & 0 & 0 & {λ}_{4}\end{matrix} )$$

In the case where B=1, we have:

$$Λ = ( \begin{matrix}{P}_{1}^{{b}_{1}} + {σ}_{1}^{2} & 0 & 0 & 0 \\ 0 & {σ}_{2}^{2} & 0 & 0 \\ 0 & 0 & {σ}_{3}^{2} & 0 \\ 0 & 0 & 0 & {σ}_{4}^{2}\end{matrix} )$$

The term P₁^{b}^{₁} describes the power of the source (b₁) in the semi-axis of the signal subspace (1-dimensional ellipsoid) it generates.

In the case where B=2, we have:

$$Λ = ( \begin{matrix}{P}_{1}^{{b}_{1} + {b}_{2}} + {σ}_{1}^{2} & 0 & 0 & 0 \\ 0 & {P}_{2}^{{b}_{1} + {b}_{2}} + {σ}_{2}^{2} & 0 & 0 \\ 0 & 0 & {σ}_{3}^{2} & 0 \\ 0 & 0 & 0 & {σ}_{4}^{2}\end{matrix} )$$

The terms P₁^{b}^{₁}^{+b}^{₂} and P₂^{b}^{₁}^{+b}^{₂} describe the power of the two sources (b₁ and b₂) in the 2 semi-axes of the signal subspace (2-dimensional ellipsoid) they generate.

In the case where B=3, we have:

$$Λ = ( \begin{matrix}{P}_{1}^{{b}_{1} + {b}_{2} + {b}_{3}} + {σ}_{1}^{2} & 0 & 0 & 0 \\ 0 & {P}_{2}^{{b}_{1} + {b}_{2} + {b}_{3}} + {σ}_{2}^{2} & 0 & 0 \\ 0 & 0 & {P}_{3}^{{b}_{1} + {b}_{2} + {b}_{3}} + {σ}_{3}^{2} & 0 \\ 0 & 0 & 0 & {σ}_{4}^{2}\end{matrix} )$$

The terms P₁^{b}^{₁}^{+b}^{₂}⁺^{₃}, P₂^{b}^{₁}^{+b}^{₂}⁺^{₃} and P₃^{b}^{₁}^{+b}^{₂}⁺^{₃} describe the power of the three sources (b₁, b₂ and b₃) in the 3 semi-axes of the signal subspace (3-dimensional ellipsoid) they generate.

In all cases, the term σₘ², m∈{1,2,3,4}, describes the power of the noise (AWGN) in the vector subspaces generated by the column vectors of the matrix [symbol] .

The principle consists in comparing the eigenvalues (λ₁, λ₂ and λ₃) of the potential signal subspace with that (λ₄) of the noise subspace starting with λ₃.

The comparison is carried out iteratively as follows:

### 1^{st} Iteration:

Initialize s₃ (∈ [symbol] ⁺*)
if λ₃>s₃λ₄ then B=3→stop

### 2^{nd} Iteration:

otherwise Initialize s₂ (∈ [symbol] ⁺*)
if λ₂>s₂λ₄ then B=2→stop

### 3^{rd} Iteration:

otherwise Initialize s₁ (∈ [symbol] ⁺*)
if λ₁>s₁λ₄ then B=1→stop
otherwise B=0→stop

The multiplicative coefficients s₃, s₂ and s₁ are determined from the distribution of the diagonal values of the matrix Λ resulting from the singular value decomposition of a covariance matrix obtained from a Gaussian matrix segment consisting of 4 Gaussian random signals coming from 4 reduced centered (or identically distributed) independent Gaussian random variables. Their value results from a compromise between probability of detection (PD) and probability of false alarm (PFA).

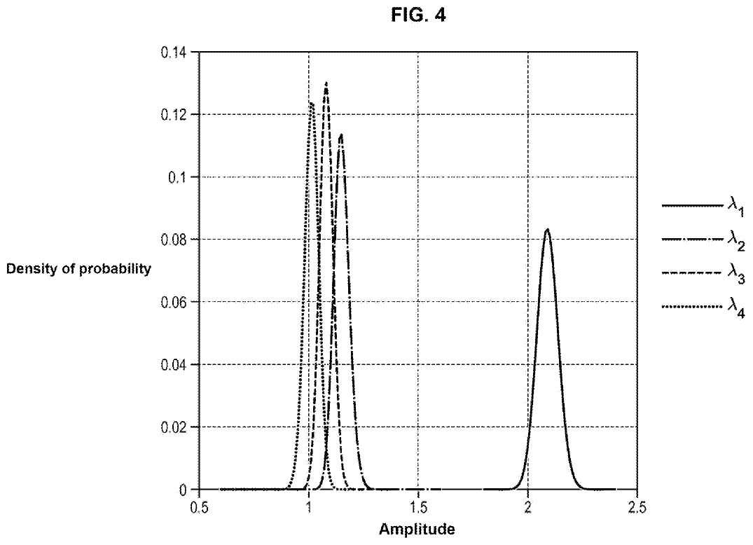

FIG. 4 represents the simulated distribution of the eigenvalues of a covariance matrix obtained from a matrix segment consisting of four Gaussian random signals of 1,024 samples coming from four reduced centered Gaussian random variables.

In the absence of sources, it is observed that:

$$\begin{matrix}\frac{\overline{{λ}_{1}}}{\overline{{λ}_{4}}} = {ρ}_{1 , 4} = 2 , 0639 = {( {ρ}_{1 , 4} )}_{noise} \\ \frac{\overline{{λ}_{2}}}{\overline{{λ}_{4}}} = {ρ}_{2 , 4} = 1 , 1362 = {( {ρ}_{2 , 4} )}_{noise} \\ \frac{\overline{{λ}_{3}}}{\overline{{λ}_{4}}} = {ρ}_{3 , 4} = 1 , 0666 = {( {ρ}_{3 , 4} )}_{noise}\end{matrix}$$

To detect the sources, it is proposed to use the following thresholds:

s₁=8(π_{1,4})ₙₒᵢₛₑ

s₂=8(π_{2,4})ₙₒᵢₛₑ

s₃=8(π_{3,4})ₙₒᵢₛₑ

In summary, to determine the number of jammers, the eigenvalues are compared with each other by successively calculating a coefficient

$${ρ}_{i , M} = \frac{{λ}_{i}}{{λ}_{M}} ,$$

i varying from M−1 to 1, the number of jammers being equal to the smallest value of i giving ρ_{i,M} greater than the threshold s; which is preferably equal to 8 times (ρ_{i,M})ₙₒᵢₛₑ (these noise values depend on the number of samples N and are calculated once for all, theoretically (when possible) or by simulation, during the design phase).

Once the number of jammers is determined, their direction is determined (step E14).

To do so, a metric is constructed for an angular domain scanned by performing the scalar product between the eigenvector associated with the noise subspace and the spatial signature function of the direction of arrival of the source to be detected. The metric thus constituted reveals at least as many notches as there are sources present in the radio environment captured by the array of antennas.

By spatial signature of a jammer it is meant the response of an antenna array to a jamming signal. Such a signature is linked to the physical characteristics of the antenna array (such as the radiation pattern of the constituent antenna elements, the coupling between these antenna elements, etc.).

The array of antennas [symbol] _{M} and the relating receive channels have been previously calibrated. The calibration is the operation that estimates (using signals dedicated to this task) and compensates for the amplitude and phase deviations between the channels due to the physical differences between the components and the lines constituting each unit of the receive chain (it includes one unit per channel). The spatial signature of a jammer is linked:
to the difference in the path of the incident signal received by the antenna element m relative to a reference antenna element (the antenna element 1 by convention).
to the physical characteristics of the antenna array (such as the radiation pattern of the constituent antenna elements, the coupling between these antenna elements, etc.).

For example, in the case of an array made up of equidistant elements disposed on a straight (aligned) line, the spacing must not exceed λ/2 (with λ the wavelength corresponding to the central frequency of the receive band considered). In our case (array made up of 4 antennal elements disposed on the 4 vertices of a square as illustrated in FIG. 2), the spacing (corresponding here to the measurement of the side of the square) must not exceed λ/2 as well. It is assumed that the antenna elements are ideal omnidirectional antennas and that the receive channels are perfectly calibrated. In addition, the phenomenon of coupling between antenna elements will not be neglected.

S(θ) denotes the spatial signature of a hypothetical jammer located on the horizon and whose azimuthal direction makes an angle θ with a direction called reference direction. This is a vector of dimensions M×1.

It is considered that the noise subspace is at least generated by the eigenvector U_{M}, that is to say the last one.

The metric is an indicator function of a direction of arrival θ comprised between [0; 2π[, the indicator being a function of a scalar between the spatial signature model of a jammer S(θ) and U_{M}^{H} which corresponds to the noise subspace of the noise space resulting from the decomposition U_{M}^{H} and S(θ) being orthogonal for a jammer in the direction θ.

Advantageously, such a metric is given by:

[symbol]

(θ)=log₂|U_{M}^{H}S(θ)|

In the presence of jammers, this metric has notches at the directions of arrival θ_{b} of the jammers. These are detected by comparing the amplitude of the notches (local minima of [symbol] ) with a predefined threshold η. Up to M−1 jammers can therefore be detected.

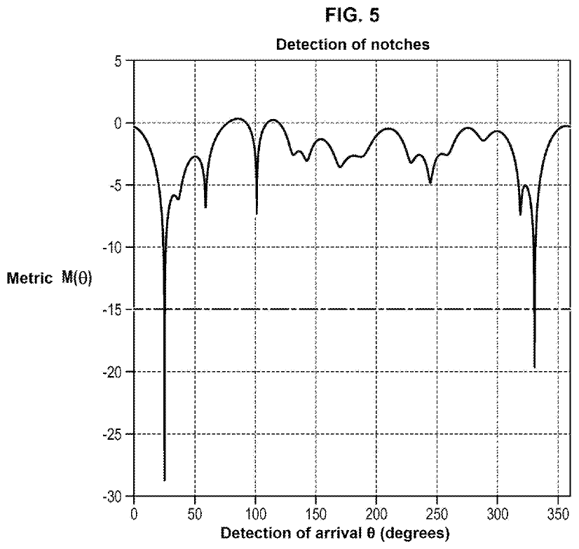

FIG. 5 illustrates the metric [symbol] (θ) in one exemplary embodiment. In this figure, the threshold is set at −15 dB, the notches being in the directions θ for which the metric [symbol] (θ) is below, namely for 25 degrees and 330 degrees.

In the case illustrated in the figure, there are two jammers. It is considered that it is the number determined in step E3. When there are more notches than detected jammers then the directions for which the notches are lower than the set threshold are taken.

In order to protect against the appearance of false alarms on θ_{b}, due to a fortuitous orthogonality of U_{M} with S(θ) when the eigenvalues λₘ with m∈1 . . . . M−1 are comparable to λ_{M}, jamming directions are successively determined over time to obtain a time sequence {θ_{b}}ₜ and this sequence is filtered with a Kalman filter (step E15).

Advantageously, the quality of the metric [symbol] can be greatly improved when the number of jammers B detected is less than or equal to M−2, in this case the following metric can be used:

$$ℳ ( θ ) = {\sum }_{m = B + 1}^{M} {log}_{2} \vert {U}_{m}^{H} S ( θ ) \vert$$

In this way, the local minima are deepened and the rest is averaged, which has the consequence of increasing the probability of detection and therefore the performance.

### Determination of the Weighting Vector (Step E2)

The case where the receiver receives the signal from a single satellite is considered.

Once the directions have been determined in the previous step, for each of these directions, a weighting vector to be applied to the signals received by each antenna is determined, said vector making it possible to attenuate the signal received in the direction of the jamming signal.

In a way, it involves creating gain notches in the angular space in the directions determined in the previous step.

Thus, the jammers are detected using a specific module (comparing the eigenvalues of the covariance matrix with at least one reference value multiplied by a threshold) and their direction of arrival using a metric whose notches are compared with a threshold.

An example where three jammers can be detected is considered. The weighting w_{CRPA} is constructed as follows:

a reference vector w⁽⁰⁾ associated with the satellite (step E21) is determined:

$${w}^{( 0 )} = ( \begin{matrix}1 \\ i \\ - 1 \\ - i\end{matrix} ) . \qquad ( 0 )$$

Such a vector makes it possible to initialize the calculation of the weighting vector.

A weighting coefficient associated with each jammer direction (here p=3 directions or jammers) (step E22) is determined:

$${w}_{jammer}^{( p )} = ( {\hat{ϕ}}_{p} ) = ( \begin{matrix}{e}^{i {𝓀𝒹}_{1} ( {\hat{ϕ}}_{p} )} \\ {e}^{i {𝓀𝒹}_{2} ( {\hat{ϕ}}_{p} )} \\ {e}^{i {𝓀𝒹}_{3} ( {\hat{ϕ}}_{p} )} \\ {e}^{i {𝓀𝒹}_{4} ( {\hat{ϕ}}_{p} )}\end{matrix} ) , 1 \leq p \leq 3 \\ where : \\ \begin{matrix}{d}_{1} ( {\hat{ϕ}}_{p} ) = 0 \\ {d}_{2} ( {\hat{ϕ}}_{p} ) = d cos ( {\hat{ϕ}}_{p} ) \\ {d}_{3} ( {\hat{ϕ}}_{p} ) = d cos ( {\hat{ϕ}}_{p} ) + d sin ( {\hat{ϕ}}_{p} ) \\ {d}_{4} ( {\hat{ϕ}}_{p} ) = d sin ( {\hat{ϕ}}_{p} )\end{matrix}$$

Let the square matrix be of order 4 (a reference vector and three jammers) (step E23).

[symbol]

=(w⁽⁰⁾wⱼₐₘₘₑᵣ⁽¹⁾wⱼₐₘₘₑᵣ⁽²⁾wⱼₐₘₘₑᵣ⁽³⁾).

Either by inverting [symbol] ( [symbol] is constructed so as to always be invertible provided that the directions of the selected jammers are distinct):

[symbol]

= [symbol] ⁻¹

Or if we note [symbol] =( [symbol] )^{H}=( [symbol] ₁ [symbol] ₂ [symbol] ₃ [symbol] ₄), the sought weight vector is given by (step E24):

w_{CRPA}= [symbol] ₁

More generally for B≤3 jammers we have:

$$ℳ = ( \begin{matrix}{w}^{( 0 )} & {\underbrace{\begin{matrix}{w}_{\hat{ϕ}}^{( 1 )} & … & {w}_{\hat{ϕ}}^{( B )}\end{matrix}}}_{B columns}\end{matrix} )$$

Complementarily, if only one jammer was detected during the preliminary detection step then the matrix [symbol] to be processed would be given by: [symbol] =(w⁽⁰⁾ wⱼₐₘₘₑᵣ⁽¹⁾), of dimensions 4×2.

As [symbol] is no longer square, we cannot simply invert it: in this case we must calculate the inverse of Moore-Penrose.

We then have:

[symbol]

= [symbol] ^{†}=( [symbol] ^{H} [symbol] )⁻¹ [symbol] ^{H}

[symbol]

=( [symbol] )^{H}=( [symbol] ₁ [symbol] ₂)

w_{CRPA}= [symbol] ₁

In the same way, if two jammers were detected then the matrix M to be processed would be given by: [symbol] (w⁽⁰⁾ wⱼₐₘₘₑᵣ⁽¹⁾ wⱼₐₘₘₑᵣ⁽²⁾), of dimensions 4×3.

[symbol]

= [symbol] ^{†}=( [symbol] ^{H} [symbol] )⁻¹ [symbol] ^{H}

[symbol]

=( [symbol] )^{H}=( [symbol] ₁ [symbol] ₂ [symbol] ₃)

w_{CRPA}= [symbol] ₁

Alternatively, in the case of an arbitrary antenna plate we have

$${w}^{( 0 )} = ( \begin{matrix}1 \\ {e}^{\frac{2 π}{M}} \\ ⋮ \\ {e}^{\frac{2 π ( M - 2 )}{M}} \\ {e}^{\frac{2 π ( M - 1 )}{M}}\end{matrix} ) .$$

### Generalization to Several Satellites, Several Jammers, Several Antennas (Step E2′)

In a complementary manner, the case where the receiver receives signals coming from several satellites is considered

It is assumed that the receiver simultaneously receives signals up to S satellites. The direction of arrival of GNSS signals is provided to the CRPA 40 module and comprises two angular components, the azimuth and the elevation, and is denoted as follows:

\hat{ξ}^{(s)}=(\hat{ξ}_{AZIM}^{(s)},\hat{ξ}_{ELEV}^{(s)}), 1≤s≤S.

B jammers are considered (as for the case where only one satellite is present).

The direction of arrival of the jammers is estimated as before and comprises a single component, the azimuth, and is noted as follows:

\hat{ϕ}^{(b)}=\hat{ϕ}_{AZIM}^{(b)}, 1≤b≤B.

It is assumed that the jammers are terrestrial (i.e. they are installed on masts, on road vehicles or even on ships; they are not airborne) so that their direction of arrival only presents an angular component: the azimuth.

The array of antennas used includes M coplanar elements (patch antennas), disposed according to a given geometric configuration (linear, circle, disk, matrix, any configuration). The antennas are indexed from 1 to M.

The antenna of index 1 is considered as the reference antenna (i.e. it is considered as the origin for the calculation of the path difference d between it and the other antennas).

The case where following condition is fulfilled is considered:

(S+B)≤M.

As before, it is sought to attenuate the signals in the directions of the identified jammers. To do so, a weight vector per tracked satellite (there are therefore, at each iteration, as many weight vectors calculated as there are tracked satellites) is calculated. The idea is to cancel both the contribution of the competing satellites of index s (there are S−1) and that of the identified jammers (up to B) by projecting gain “notches” in the direction of these sources and to achieve a gain on the signals originating from the GNSS satellite of interest of index [symbol] .

The following set of weighting coefficients (we speak of a reference vector for the satellite of interest) is calculated (step E21′) regarding each satellite (including the satellite of interest of index s):

$${w}_{\hat{ξ}}^{( s )} = ( \begin{matrix}{e}^{i {𝓀𝒹}_{1} ( {\hat{ξ}}^{( s )} )} \\ {e}^{i {𝓀𝒹}_{2} ( {\hat{ξ}}^{( s )} )} \\ {e}^{i {𝓀𝒹}_{3} ( {\hat{ξ}}^{( s )} )} \\ ⋮ \\ {e}^{i {𝓀𝒹}_{M - 1} ( {\hat{ξ}}^{( s )} )} \\ {e}^{i {𝓀𝒹}_{M} ( {\hat{ξ}}^{( s )} )}\end{matrix} ) = ( \begin{matrix}1 \\ {e}^{i {𝓀𝒹}_{2} ( {\hat{ξ}}_{AZIM}^{( s )} , {\hat{ξ}}_{ELEV}^{( s )} )} \\ {e}^{i {𝓀𝒹}_{3} ( {\hat{ξ}}_{AZIM}^{( s )} , {\hat{ξ}}_{ELEV}^{( s )} )} \\ ⋮ \\ {e}^{i {𝓀𝒹}_{M - 1} ( {\hat{ξ}}_{AZIM}^{( s )} , {\hat{ξ}}_{ELEV}^{( s )} )} \\ {e}^{i {𝓀𝒹}_{M} ( {\hat{ξ}}_{AZIM}^{( s )} , {\hat{ξ}}_{ELEV}^{( s )} )}\end{matrix} ) for 1 \leq s \leq S$$

[symbol] : denotes the wave number.
dₘ: denotes the path difference relative to the reference antenna (antenna, of index 1). It depends on the geometric configuration of the array of antennas. w_{ξ}^{(s)} is a vector whose each component corresponds to a weighting coefficient.

In a similar manner, regarding the jammers, the following set of weighting coefficients (step E22′) is calculated.

$${w}_{\hat{ϕ}}^{( b )} = ( \begin{matrix}{e}^{i {𝓀𝒹}_{1} ( {\hat{ϕ}}^{( b )} )} \\ {e}^{i {𝓀𝒹}_{2} ( {\hat{ϕ}}^{( b )} )} \\ {e}^{i {𝓀𝒹}_{3} ( {\hat{ϕ}}^{( b )} )} \\ ⋮ \\ {e}^{i {𝓀𝒹}_{M - 1} ( {\hat{ϕ}}^{( b )} )} \\ {e}^{i {𝓀𝒹}_{M} ( {\hat{ϕ}}^{( b )} )}\end{matrix} ) = ( \begin{matrix}1 \\ {e}^{i {𝓀𝒹}_{2} ( {\hat{ϕ}}_{AZIM}^{( b )} )} \\ {e}^{i {𝓀𝒹}_{3} ( {\hat{ϕ}}_{AZIM}^{( b )} )} \\ ⋮ \\ {e}^{i {𝓀𝒹}_{M - 1} ( {\hat{ϕ}}_{AZIM}^{( b )} )} \\ {e}^{i {𝓀𝒹}_{M} ( {\hat{ϕ}}_{AZIM}^{( b )} )}\end{matrix} ) for 1 \leq b \leq B$$

The coefficient w_{ξ}^{(s)} plays a role similar to the role played by w⁽⁰⁾ (see above): it is a vector that we will “constrain” in order to create a gain towards the GNSS satellite of interest and gain notches towards jammers and the other GNSS satellites (which could potentially disrupt the receipt of the signals originating from the GNSS satellite of interest; this is usually not the case because in general the GNSS signals from the same system are designed not to jam each other).

Let then be the following rectangular matrix of dimensions M×(S+B) (the matrix is square if S+B=M) (step E23′)

$$ℳ = ( \begin{matrix}{w}_{\hat{ξ}}^{( 𝓈 )} & {\underbrace{\begin{matrix}… & {w}_{\hat{ξ}}^{( s )} & …\end{matrix}}}_{\begin{matrix}S - 1 columns \\ s \neq 𝓈\end{matrix}} & {\underbrace{\begin{matrix}{w}_{\hat{ϕ}}^{( 1 )} & {w}_{\hat{ϕ}}^{( 2 )} & … & {w}_{\hat{ϕ}}^{( B - 1 )} & {w}_{\hat{ϕ}}^{( B )}\end{matrix}}}_{B columns}\end{matrix} )$$

Then we calculate the pseudo-inverse of Moore-Penrose of M:

[symbol]

= [symbol] ^{†}=( [symbol] ^{H} [symbol] )⁻¹ [symbol] ^{H}

Or, if it is square, we simply reverse it:

[symbol]

= [symbol] ⁻¹

where:
(⋅)^{H}: denotes the operation “transposition+complex conjugation”

If we note W= [symbol] ^{H}=( [symbol] ₁ [symbol] ₂ . . . [symbol] _{S+B-1} [symbol] _{S+B}) then the set of weighting coefficients associated with the satellite of interest of index [symbol] is given by (step E24′) w_{CRPA}⁽ [symbol] ⁾= [symbol] ₁.

It is noted here that in the case of a single satellite w_{ξ}( [symbol] ) is replaced by

$${w}^{( 0 )} = ( \begin{matrix}1 \\ {e}^{\frac{2 π}{M}} \\ ⋮ \\ {e}^{\frac{2 π ( M - 2 )}{M}} \\ {e}^{\frac{2 π ( M - 1 )}{M}}\end{matrix} ) .$$

1.-10. (canceled)

11. A method for processing a radio navigation signal coming from a satellite received by a radio navigation receiver comprising several receiving antennas, each antenna being configured to receive signals coming from a satellite of interest, of at least one jammer and possibly at least another satellite in given directions, the method comprising steps of:
detecting from the signal received by each antenna, at least one direction of a jamming signal;
attenuating the detected jamming signal in the detected direction;
wherein detecting the direction of a jamming signal comprises the steps of:
determining a covariance matrix function of the signals received by each antenna given by R_{ZZ}=1/NZ^{H}Z with Z a matrix of size N×M where each column corresponds to the signal received by each antenna, N denoting the number of samples acquired during a set period ΔT and M being the number of antennas;
carrying out a singular value decomposition of the covariance matrix:
$${R}_{ZZ} = {\sum }_{m = 1}^{M} {λ}_{m} {U}_{m} {U}_{m}^{H}$$
where λₘ are the eigenvalues, components being characteristic of the useful and jamming signals and other noise characteristics;
comparing the eigenvalues together so as to detect the presence of at least one jammer;
determining an indicator function of a direction of arrival θ comprised between [0; 2π[, the indicator being a function of a scalar between a spatial signature model of a jammer S(θ) and U_{M}^{H} which corresponds to the noise subspace of the noise space resulting from the decomposition, U_{M}^{H} and S(θ) being orthogonal for a jammer in the direction θ;
a jammer being present in the direction θ for which the indicator is lower than a given threshold.

12. The method according to claim 11, wherein the comparison comprises a determination of a number of jammers by comparison in pairs of the eigenvalues by successively calculating a coefficient
$${ρ}_{i , M} = \frac{{λ}_{i}}{{λ}_{M}}$$
varying from M−1 to 1, the number of jammers being equal to i for ρ_{i,M} greater than a determined threshold, preferably equal to 8(ρ_{i,M})ₙₒᵢₛₑ.

13. The method according to claim 11, wherein the indicator is given by [symbol] (θ)=log₂|U_{M}^{H}S(θ)|, a jammer being present in the direction θ for which the indicator is lower than a given threshold.

14. The method according to claim 12, wherein a detected number B of jammers is known, a jammer being present in the B directions θ for which the corresponding indicator is lower than the threshold.

15. The method according to claim 12, wherein the detected number of jammers is less than or equal to M−2, the indicator being given by [symbol] (θ)=Σ_{m=B+1}^{M} log₂|Uₘ^{H}S(θ)|, where B is the number of jammers, a jammer being present in the M−2 directions θ lower than the threshold.

16. The method according to claim 11, wherein several directions are obtained over time for each detected jammer, the method comprising a time filter of the directions obtained for each jammer.

17. The method according to claim 11, wherein the attenuation comprises the determination of a set of weighting coefficients w_{CRPA} Or w_{CRPA}⁽ [symbol] ⁾ associated with a satellite of interest making it possible to attenuate the jamming signal received in the thus detected directions and making it possible to attenuate, where appropriate, the signals coming from other satellites so as to optimize the signal coming from the satellite of interest.

18. The method according to claim 17, the receiver receiving signals coming from a single satellite, the determination of the coefficient w_{CRPA} making it possible to attenuate the jamming signal received in the determined directions comprises the steps of:
determining a reference vector
$${w}^{( 0 )} = ( \begin{matrix}1 \\ i \\ - 1 \\ - i\end{matrix} ) ;$$
determining a weighting coefficient associated with each jammer or jamming direction
$${w}_{jammer}^{( p )} ( {\hat{ϕ}}_{p} ) = ( \begin{matrix}{e}^{i {𝓀𝒹}_{1} ( {\hat{ϕ}}_{p} )} \\ {e}^{i {𝓀𝒹}_{2} ( {\hat{ϕ}}_{p} )} \\ {e}^{i {𝓀𝒹}_{3} ( {\hat{ϕ}}_{p} )} \\ {e}^{i {𝓀𝒹}_{4} ( {\hat{ϕ}}_{p} )}\end{matrix} ) , 1 \leq p \leq B$$
where d₁ (\hat{ϕ}ₚ)=0, d₂(\hat{ϕ}ₚ)=d cos (\hat{ϕ}ₚ), d₃ (\hat{ϕ}ₚ)=d cos (\hat{ϕ}ₚ)+d sin(\hat{ϕ}ₚ), d₄(\hat{ϕ}ₚ)=d sin (\hat{ϕ}ₚ)
determining a rectangular or square matrix of size 4×(B+1);
$$ℳ = ( \begin{matrix}{w}^{( 0 )} & {\underbrace{\begin{matrix}{w}_{\hat{ϕ}}^{( 1 )} & … & {w}_{\hat{ϕ}}^{( B )}\end{matrix}}}_{B columns}\end{matrix} )$$
determining the set of weighting coefficients
w_{CRPA}= [symbol] ₁
with [symbol] ₁ the first component of the vector [symbol] =( [symbol] )^{H}=( [symbol] ₁ . . . [symbol] _{B-1} [symbol] _{B}) with [symbol]
= [symbol] ^{†}=( [symbol] ^{H} [symbol] )⁻¹ [symbol] ^{H}
if B<3 or [symbol] = [symbol] ⁻¹ if B=3.

19. The method according to claim 17, wherein the receiver receives signals from S>1 satellites, the determination of the coefficient making it possible to optimize the received signal associated with a satellite of interest and making it possible to attenuate the jamming signal in the determined directions and that of the other satellites, comprises the steps of:
determining a weighting coefficient w_{\hat{ξ}}^{(s)} associated with each satellite s:
$${w}_{\hat{ξ}}^{( s )} = ( \begin{matrix}{e}^{i {𝓀𝒹}_{1} ( {\hat{ξ}}^{( s )} )} \\ {e}^{i {𝓀𝒹}_{2} ( {\hat{ξ}}^{( s )} )} \\ {e}^{i {𝓀𝒹}_{3} ( {\hat{ξ}}^{( s )} )} \\ ⋮ \\ {e}^{i {𝓀𝒹}_{M - 1} ( {\hat{ξ}}^{( s )} )} \\ {e}^{i {𝓀𝒹}_{M} ( {\hat{ξ}}^{( s )} )}\end{matrix} ) = ( \begin{matrix}1 \\ {e}^{i {𝓀𝒹}_{2} ( {\hat{ξ}}_{AZIM}^{( s )} , {\hat{ξ}}_{ELEV}^{( s )} )} \\ {e}^{i {𝓀𝒹}_{3} ( {\hat{ξ}}_{AZIM}^{( s )} , {\hat{ξ}}_{ELEV}^{( s )} )} \\ ⋮ \\ {e}^{i {𝓀𝒹}_{M - 1} ( {\hat{ξ}}_{AZIM}^{( s )} , {\hat{ξ}}_{ELEV}^{( s )} )} \\ {e}^{i {𝓀𝒹}_{M} ( {\hat{ξ}}_{AZIM}^{( s )} , {\hat{ξ}}_{ELEV}^{( s )} )}\end{matrix} ) for 1 \leq s \leq S$$
where [symbol] : denotes the wave number, dₘ denotes the path difference relative to the reference antenna, \hat{ξ}^{(s)}=(\hat{ξ}_{AZIM}^{(s)}, \hat{ξ}_{ELEV}^{(s)}) is the direction of the arrival of the received signal coming from satellite of index s, \hat{ξ}_{AZIM}^{(s)} being the azimuthal component and \hat{ξ}_{ELEV}^{(s)} being the elevation component;
determining a weighting coefficient w\hat{\hat{ϕ}}^{(b)} associated with each jammer in each determined direction
$${w}_{\hat{ϕ}}^{( b )} = ( \begin{matrix}{e}^{i {𝓀𝒹}_{1} ( {\hat{ϕ}}^{( b )} )} \\ {e}^{i {𝓀𝒹}_{2} ( {\hat{ϕ}}^{( b )} )} \\ {e}^{i {𝓀𝒹}_{3} ( {\hat{ϕ}}^{( b )} )} \\ ⋮ \\ {e}^{i {𝓀𝒹}_{M - 1} ( {\hat{ϕ}}^{( b )} )} \\ {e}^{i {𝓀𝒹}_{M} ( {\hat{ϕ}}^{( b )} )}\end{matrix} ) = ( \begin{matrix}1 \\ {e}^{i {𝓀𝒹}_{2} ( {\hat{ϕ}}_{AZIM}^{( b )} )} \\ {e}^{i {𝓀𝒹}_{3} ( {\hat{ϕ}}_{AZIM}^{( b )} )} \\ ⋮ \\ {e}^{i {𝓀𝒹}_{M - 1} ( {\hat{ϕ}}_{AZIM}^{( b )} )} \\ {e}^{i {𝓀𝒹}_{M} ( {\hat{ϕ}}_{AZIM}^{( b )} )}\end{matrix} ) for 1 \leq b \leq B$$
determining a matrix [symbol] of size M×(S+B) where S is the number of satellites, B is the number of jammers or jamming directions and M is the number of antennas:
$$ℳ = ( \begin{matrix}{w}_{\hat{ξ}}^{( 𝓈 )} & {\underbrace{\begin{matrix}… & {w}_{\hat{ξ}}^{( s )} & …\end{matrix}}}_{\begin{matrix}S - 1 columns \\ s \neq 𝓈\end{matrix}} & {\underbrace{\begin{matrix}{w}_{\hat{ϕ}}^{( 1 )} & {w}_{\hat{ϕ}}^{( 2 )} & … & {w}_{\hat{ϕ}}^{( B - 1 )} & {w}_{\hat{ϕ}}^{( B )}\end{matrix}}}_{B columns}\end{matrix} )$$
determining the set of weighting coefficients associated with a satellite [symbol] of interest
w_{CRPA}⁽ [symbol] ⁾⁼ [symbol] ₁
with [symbol] ₁ the first component of the vector [symbol] = [symbol] ^{H}=( [symbol] ₁ [symbol] ₂ . . . [symbol] _{S+B-1} [symbol] _{S+B}) with [symbol] = [symbol] ^{†}=( [symbol] ^{H} [symbol] )⁻¹ [symbol] ^{H} if S+B<M or [symbol] = [symbol] ⁻¹ if S+B=M (⋅)^{H}: denoting the operation “transposition (noted (⋅)^{T})+complex conjugation (noted (⋅)*)”.

20. A non-transitory computer-readable medium storing code instructions for implementing a method according to claim 11.
